(19) United States
(12) Patent Application Publication
(10) Pub. No.: US 2026/0332246 A1
(43) Pub. Date: Oct. 22, 2026

(54) NEXT GENERATION CELLULAR - SATELLITE SIGNAL AMPLIFICATION AND BEAMFORMING GUIDANCE EMPLOYING OPEN RADIO ACCESS NETWORK

(71) Applicant: AT&T Intellectual Property I, L.P., Atlanta, GA (US)

(72) Inventors: Joseph Soryal, Glendale, NY (US); Venson Shaw, Kirkland, WA (US)

(73) Assignee: AT&T Intellectual Property I, L.P., Atlanta, GA (US)

(21) Appl. No.: 19/181,538

(22) Filed: Apr. 17, 2025

(51) Int. Cl. H04B 7/185; H04W 36/14

(52) U.S. Cl. CPC H04B 7/18534; H04B 7/18515; H04B 7/18541; H04B 7/18565; H04B 7/18582; H04W 36/14

(57) ABSTRACT

Aspects of the subject disclosure may include, for example, detecting satellite band signals from a user equipment (UE), the satellite band signals intended for reception by an earth orbiting satellite, amplifying the satellite band signals to produce a repeater signal, and transmitting the repeater signal for reception by the earth orbiting satellite to enhance satellite communication between the UE and the earth orbiting satellite by selectively amplifying and directing communication signals based on real-time signal conditions. Other embodiments are disclosed.

### FIELD OF THE DISCLOSURE

The subject disclosure relates to communication between terrestrial user equipment (UE) and communication satellites.

### BACKGROUND

In next-generation wireless networks, many user equipment (UE) devices will be able to communicate directly with earth-orbiting satellites. However, communications between a satellite and a terrestrial radio are readily impacted by weather, clouds and other factors. These factors can create impediments to reliable communication between terrestrial UEs and the satellites.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C depicts an illustrative embodiment of a method in accordance with various aspects described herein.

FIG. 2D depicts an illustrative embodiment of a method 250 in accordance with various aspects described herein. The method 250 illustrates one embodiment of operation of an SSA at a RAN site operating in an active mode of operation.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system and method that enhances satellite communication by integrating Satellite Signal Amplifiers (SSAs) within an Open Radio Access Network (O-RAN) architecture, allowing user equipment to communicate with both terrestrial and satellite networks. These SSAs operate in passive and active modes to amplify and process signals, utilizing techniques such as error correction, signal reconstruction, and beamforming to optimize signal transmission and reception. The system coordinates with a Satellite Core Manager (SCM) to support seamless handovers and improve communication reliability in areas with limited coverage. Other embodiments are described in the subject disclosure.

One or more aspects of the subject disclosure include detecting satellite band signals from a user equipment (UE), the satellite band signals intended for reception by an earth orbiting satellite, amplifying the satellite band signals to produce a repeater signal, and transmitting the repeater signal for reception by the earth orbiting satellite to enhance satellite communication between the UE and the earth orbiting satellite by selectively amplifying and directing communication signals based on real-time signal conditions.

One or more aspects of the subject disclosure include detecting satellite band signals from a user equipment (UE), the UE attached to a terrestrial communication network, the satellite band signals intended for reception by an earth orbiting satellite of a non-terrestrial communication network, analyzing a signal quality of the satellite band signals, selectively amplifying the satellite band signals to produce a repeater signal, wherein the amplifying is based on a comparison between the signal quality of the satellite band signals and a signal quality threshold, and transmitting the repeater signal for reception by the earth orbiting satellite to enhance satellite communication between the UE and the earth orbiting satellite based on real-time signal conditions.

One or more aspects of the subject disclosure include detecting a transmission of satellite band signals from a user equipment (UE) in a terrestrial communications network, the satellite band signals intended for reception by an earth orbiting satellite of a non-terrestrial communications network, determining a signal quality parameter of the satellite band signals, comparing the signal quality parameter of the satellite band signals with a signal quality threshold, selectively causing amplification of the satellite band signals, forming a repeater signal, wherein the causing amplification is responsive to the comparing of the signal quality parameter of the satellite band signals and the signal quality threshold, and causing transmission of the repeater signal for reception by the earth orbiting satellite to enhance satellite communication between the UE and the earth orbiting satellite in response to real time signal degradation of the satellite band signals.

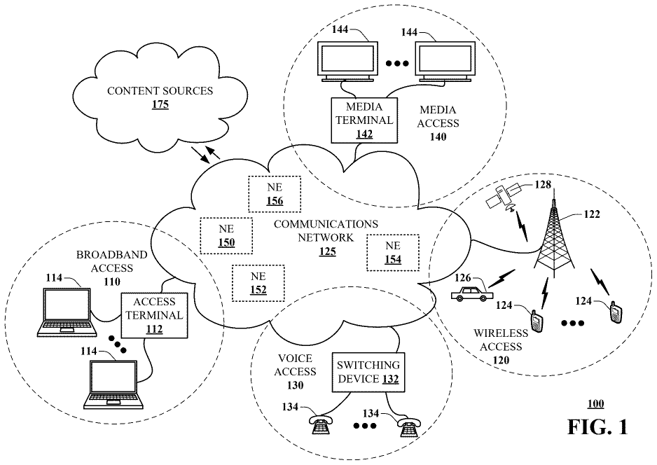

Referring now to FIG. 1, a block diagram is shown illustrating an example, non-limiting embodiment of a system 100 in accordance with various aspects described herein. For example, system 100 can facilitate in whole or in part detecting satellite band signals from a user equipment and selectively amplifying the signals in a repeater arrangement to improve reception by a satellite in an environment with limited coverage and substantial interference. In particular, a communications network 125 is presented for providing broadband access 110 to a plurality of data terminals 114 via access terminal 112, wireless access 120 to a plurality of mobile devices 124 and vehicle 126 via base station or access point 122 or satellite 128, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices. In various embodiments, the satellite 128 can be configured for bi-directional communication with one or more access points, with one or more base stations, and/or with one or more mobile devices (e.g., direct-to-cell). In various embodiments, the satellite 128 can comprise a Low Earth Orbit (LEO) satellite or a Geostationary Orbit (GEO) satellite.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Current mobile devices or user equipment (UE) such as mobile devices 124 and vehicle 126 interact almost exclusively with a base station or access point 122. Access to a satellite such as satellite 128 is currently only on an emergency basis, and may be limited to text messaging only. However, in fifth generation (5G) cellular and sixth generation (6G) cellular networks, a UE will have dual communication capability, enabling access to both a terrestrial base station such as 122 as well as the satellite 128. The UE may include separation communication circuits, one for terrestrial communications with the cellular network and one for communication with satellites of the satellite network. Such an improvement will enable broader coverage to terrestrial areas where cellular coverage is currently poor or nonexistent.

Generally, a UE such as a mobile phone has limited transmit capability to reliably reach a satellite in orbit. For terrestrial transmissions, transmit power of a UE may be limited to 600 mW, for example. In contrast, a base station or other site in a radio access network (RAN) of the mobile communications network is equipped with a powerful radio for reliable transmission between the satellite and the RAN site. However, in accordance with aspects described herein, a UE may communicate with a nearby RAN site which may then function as a repeater to receive a radio signal from the UE, amplify the received radio signal and transmit a more powerful radio signal to the satellite.

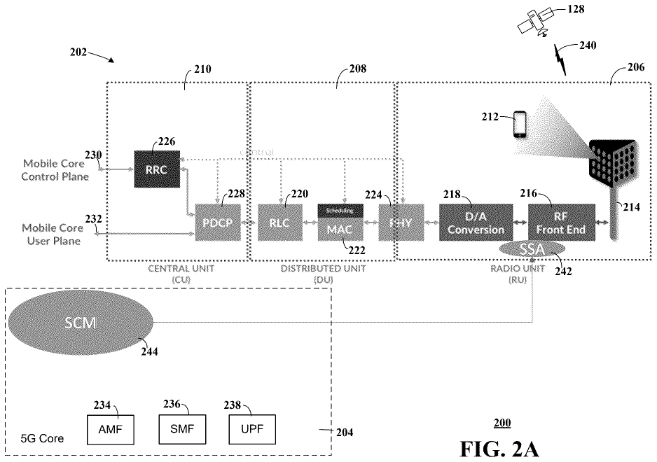

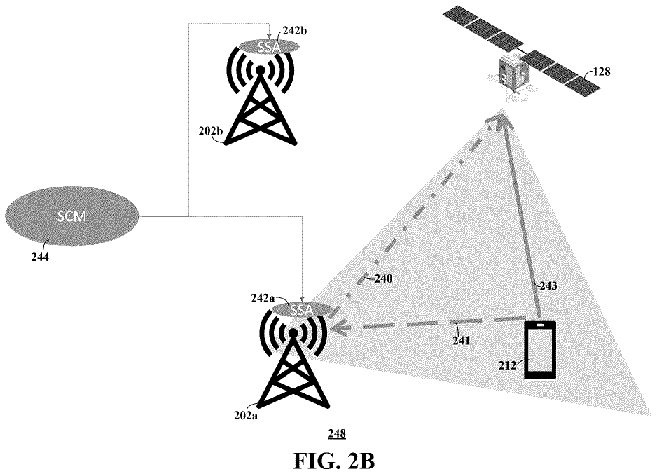

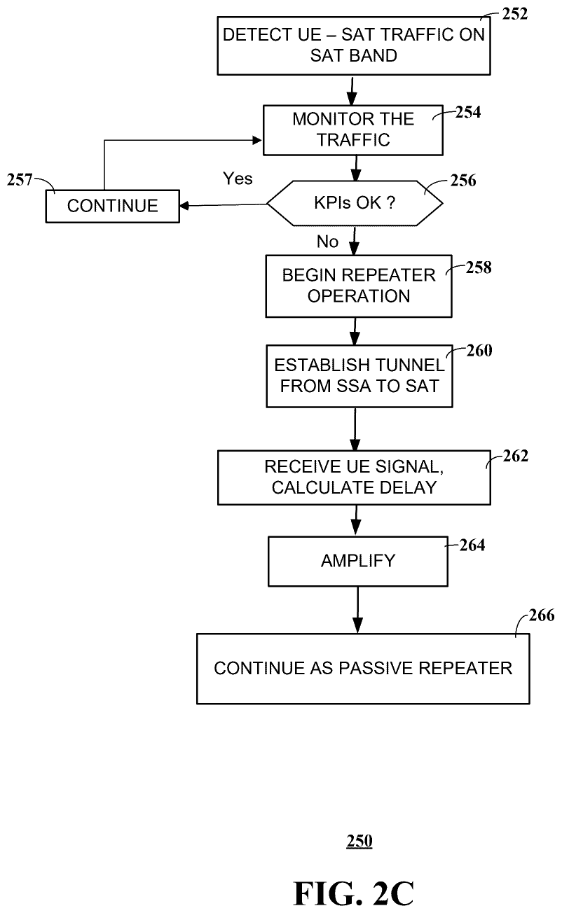

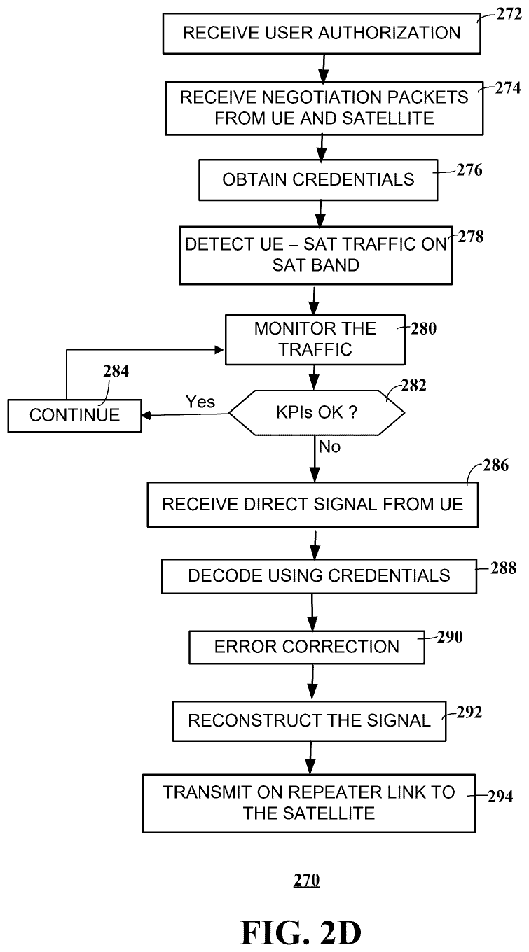

FIG. 2A is a block diagram illustrating an example, non-limiting embodiment of a system 200 functioning within the communication network of FIG. 1 in accordance with various aspects described herein. In the example, the system 200 includes an Open Radio Access Network (ORAN) 202 and a core network 204. Other embodiments may include alternative or additional components.

The ORAN 202 in this example includes a radio unit (RU) 206, a distributed unit (DU) 208 and a central unit (CU) 210. ORAN generally is an architecture for radio access networks (RAN). The RAN is the part of the mobile communications network that connects individual user equipment like UE 212 to the core network 204. The RAN communicates with the user equipment via radio signals according to an air interface standard such as the 5G or 6G standards published by the 3^{rd} Generation Partnership Project (3GPP). The RU 206 handles radio frequency (RF) processing of communication signals with the UE 212. More specifically, in the RU 206, radio frequency signals are transmitted, received, amplified and digitized.

In the example embodiment, the RU 206 includes an antenna 214, a radio frequency (RF) front end 216, and a digital to analog converter 218. The digital to analog converter 218 receives digital baseband signals from the DU 208 and converts the digital signals to analog signals. The RF front end 216 in turn receives the analog signals and processes the analog signals for transmission at the antenna 214. Such processing may include filtering, frequency conversion, carrier modulation and amplification. The amplified analog signals are provided to the antenna 214 for transmission to user equipment such as UE 212 in a service area served by the RU 206.

The DU 208 handles lower layers of the radio protocol stack, including the radio link control (RLC) layer 220, medium access control (MAC) layer 222, and upper portions of the physical (PHY) layers 224. The DU 208 generally handles real-time processing of baseband signals.

Similarly, the CU 210 handles higher layers of the radio protocol stack. More specifically, the CU 210 handles the radio resource control (RRC) layer 226, the service data adaptation protocol (SDAP) layer, and the packet data convergence protocol (PDCP) layer 228 Generally, the CU 210 is responsible for non-real-time functions and higher-layer processing. The CU 210 communicates with the core 204 over a control plane 230 and a user plane 232.

The core network 204 provides a number of basic functions for the system 200. The core network 204 includes, for example, an access and mobility function (AMF) 234, a session management function (SMF) 236 and a user plane function (UPF) 238 for managing user devices such as the UE 212. For example, the AMF 234 manages connection and mobility of UEs in the 5G network. The UPF 238 provides connection between UEs such as the UE 212 and external networks such as the public internet.

As noted, some ORAN 202 sites such as the RU 206 include satellite communication capability. The RU 206 may communicate over a repeater link 240 with satellites such as the satellite 128. The satellite 128 may be part of a 5G non-terrestrial network (NTN). The RAN site may include a separate ground station for satellite communications, or the satellite communication circuits may be incorporated with the RU 206 for the cellular network 201. The terrestrial equipment for satellite communication will use sufficient transmit power to reliably communicate with the satellite 128. Moreover, the repeater link 240 may provide very high data rates on uplink and downlink with the satellite.

Some portions of service areas served by RUs such as RU 206 do not have reliable coverage by the 5G terrestrial network. This may include rural or remote areas, or areas within a coverage that simply have poor or unreliable or intermittent coverage form the RU 206. On the other hand, the satellite may provide better coverage for some areas.

In accordance with some aspects described herein, the ORAN 202 includes a satellite transceiver for radio communication between the ORAN 202 and the satellite 128. Moreover, the satellite transceiver is equipped with a repeater circuit or functions as a repeater for communications with a UE such as UE 212.

In a radio network, a repeater is generally a device that receives a radio signal and then re-transmits it, often at a higher power or on a different frequency. This process extends the range of radio communications. The primary purpose of a repeater is to overcome limitations in radio signal range. These limitations can be due to distance or obstacles like buildings or hills for example. By re-transmitting the received signal, the repeater effectively “boosts” it, allowing for communication over greater distances. As an example, a typical repeater consists of a receiver and a transmitter. The receiver receives a signal on one frequency, the input frequency, and then re-transmits that signal on another frequency, the output frequency.

The ORAN 202 may be equipped with a repeater to enable and to improve communication between a terrestrial UE such as UE 212 and a satellite such as satellite 128. The repeater may have improved radio characteristics, including transmit power, to provide more reliable communication to the satellite 128, especially in the case of a difficult radio environment such as clouds and precipitation. The ORAN 202 may enable passive and active software-defined network (SDN) amplifiers in the ORAN or associated with the ORAN to amplify and further rectify the signals between the UE and satellites without being part of the communication logical link.

In accordance with some embodiments, the RU 206 includes a satellite signal amplifier (SSA) 242. The SSA 242 is associated with the RF front end 216 of the RU 206. Any suitable radio design or implementation may be used including for example, an intelligent module added to the components of the RU 206 or an embedded process, a microprocess or an instantiation, incorporated into the hardware and software of the RU 206. In embodiments, the SSA 242 operates primarily as a control function and does not include RF components of its own. Instead, the ORAN 202 includes an RF front end 216 for the terrestrial network and, possibly separately incorporated, an RF front end for communication with the satellites of the non-terrestrial network. In embodiments, the functionality of the SSA 242 may be located in any suitable location including the DU 208 and the CU 210. Locating the SSA 242 near the RF front end 216 may provide simplicity of interoperation among the components.

In accordance with these embodiments, then, a mobile communications network including the ORAN 202 may have SSAs like SSA 242 all over the country, providing wide-area access to high-powered, high-data rate links to satellites of the non-terrestrial network. For managing these SSAs, the network further includes a satellite core manager (SCM) 244. The SCM 244 operates as a manager for the network of SSAs. The SCM 244 may be located in any suitable location, including the 5G core network 204 as illustrated in FIG. 2A or in a cloud network location which is network-accessible by all the SSAs.

In embodiments, the SSA 242 may include software defined elements that get spun-up or activated up detection of a satellite signal at the ORAN RF front end 216. Thus, the SSA 242 includes native intelligence for sensing satellite activity or presence and controlling the components of the RF front end 216. The sensed satellite activity may originate with a satellite such as satellite 128 when the satellite coverage area illuminates the site of the ORAN 202. Sensing the presence of a satellite carrier, for example, may activate the SSA 242 from a quiescent state. Also, sensing activity of a UE such as UE 212 seeking to communicate with the satellite via the RU 216 may activate the SSA from the quiescent state. When not activated, the SSA 242 may remain in a low-power state.

In embodiments, the SSA 242 at a RAN site has two modes of operation. In a passive mode, the SSA 242 detects a satellite band signal transmission, amplifies the signal and retransmits the signal to the satellite 128. Any suitable amplification may be performed including enhancing the signal amplitude, filtering, and shifting from a receive frequency to a new transmit frequency. The SSA 242 detects if the detected signal is transmitted by the satellite 128 or intended for transmission to the satellite 128. The SSA 242 may detect directionality of the received signal in any suitable manner. The SSA transmits the amplified signal in the direction the original signal was travelling. Other suitable information, such as network addressing may be applied before transmission.

In an active mode, the SSA 242 may have access to the signal content from the UE 212 intended for the satellite 128. For example, the SSA 242 is located inline in the communications link between the UE 212 and the satellite 128. The SSA 242 may detect the content of the signal including packet headers and other information, and may use the signal information to perform signal processing. The received signal information may originate with either the UE 212 or the satellite 128, or both. Upon processing the signal, the SSA 242 can intelligently reconstruct the signal. For example, the signal content may include error detection bits and other integrity mechanisms embedded in the signal that may be used for error correction or to prompt a retransmission. In another example, the SSA 242 may re-packetize the payload information of the received signal for transmission on the next leg. Thus, in active mode, the SSA 242 may do more than merely amplifying the signal. Amplification and other signal processing for reliably repeating the signal may occur as well as any operations on the content of the signal.

FIG. 2B is a block diagram illustrating an example, non-limiting embodiment of a system 248 functioning within the communications network 125 of FIG. 1 in accordance with various aspects described herein. FIG. 2B illustrates communication between a first ORAN 202a including a first SSA 242a, a second ORAN 202b including a second SSA 242b, a SCM 244, a UE 212 and a satellite 128. The embodiment is intended to be exemplary only. Other embodiments may include large numbers of ORANs in communication with a core network and with the SCM. The system 248 provides terrestrial communication between UEs such as the UE 212 and the mobile communications network including ORANs such as the first ORAN 202a and the second ORAN 202b. Further, the system 248 provides communication with a non-terrestrial network including satellites such as the satellite 128. The UE 212 may be equipped with a first communication circuit for communication with the ORANs and a second communication circuit for direct communication with satellites including the satellite 128.

Thus, the UE 212 can communicate on a satellite link 243 directly with the satellite 128. The communication on direct link 243 is on a frequency band assigned for satellite communications with satellites including the satellite 128. The communication by the UE 212 on the satellite band is also detected on a link 241 between the UE 212 and the first ORAN 202b. In accordance with aspects described herein, the first SSA 242 may operate in a passive mode or an active mode to detect the satellite band communications intended by the UE 212 for the satellite 128. In response, the SSA 242a may operate as a repeater and passively amplify the signal of the link 241 and transmit the same signal on link 240 to the satellite 128. The signal on the link 240,which may be referred to as a repeater link, may be transmitted at the same frequency and with other properties so as to substantially match the signal on the link 243, but at a much higher transmit power level. The link 243 may be referred to as a direct link. In this manner, the information to be conveyed by the UE 212 to the satellite 128 is boosted or amplified to ensure reliable reception by the satellite 128.

The SSA may communicate information to the satellite 128 to improve reliability of the communication. In embodiments, the SSA 242 may determine a time delay between the direct signal on the direct link 243 and the repeater signal on the repeater link 240. Information about this time delay may be communicated to the satellite 128 for use by the satellite 128 to coherently receive the two signals on the repeater link 240 and the direct link 243. This helps ensure that one signal is not noise to reception of the other signal.

Further, the satellite 128 may use a multiple-input, multiple-output (MIMO) antenna for communication with terrestrial radios such as the first ORAN 202a and the UE 212. The SSA 242a of the ORAN 202a may instruct the satellite 128 which MIMO antenna elements to use for reception of the two signals on the link 240 and the link 243. This may permit the MIMO antenna to steer its reception area in a desired direction such as toward the UE 212 or toward the ORAN 202a. Any useful antenna steering information may be provided by the SSA 242a to enable the satellite 128 to receive the signals from the link 240 from the first ORAN 202a and on the link 243 from the UE 212. The signals received at the MIMO antenna of the satellite 128 may be combined by the receiver of the satellite 128 to detect content of the transmissions received by the satellite 128.

The SCM 244 and SSAs including SSA 242a and SSA 242b coordinate amongst themselves to support the signal amplification and signal enhancing for a mobile UE. In an example, first 202a ORAN communicates to second ORAN 202b that a particular UE 212 is heading towards the second ORAN 202b and the SSA 242a for first ORAN 202a was involved in satellite signal amplification and enhancement. In this example, the SCM 244 notifies the SSA 242b for second ORAN 202b to prepare itself to perform the same functionalities when the UE 212 arrives to its coverage area and communication signals between the UE 212 and the satellite 128 satellite are sub optimal. Sub-optimality may be measured in any suitable manner such as by comparing current KPIs with threshold values or based on historical information.

The interaction between an SSA and the satellite provides information to the SSA regarding the direction of the satellite. This information is extended by the SSA to the SCM. In this manner, the SSAs and SCM 244 are better equipped to advise UEs including the UE regarding the direction of the uplink signal and potential satellite handoff from a first satellite to a second satellite if the first satellite becomes out of range.

FIG. 2C depicts an illustrative embodiment of a method 250 in accordance with various aspects described herein. The method 250 illustrates one embodiment of operation of an SSA at a RAN site operating in a passive mode of operation. In the passive mode of operation, the UE is not aware that the SSA is operating as a repeater. The UE only has information that it is communicating on the satellite frequency, directly with the satellite.

FIG. 2C illustrates method 250 for operating a Satellite Signal Amplifier (SSA) in a passive mode within an Open Radio Access Network (ORAN) system, as depicted in FIGS. 2A and 2B. The method begins with step 252, where the SSA detects user equipment (UE) and satellite traffic on the satellite band. This detection is facilitated by the receiver module of the SSA, as shown in FIG. 2A, where the SSA 242 is integrated with the RF front end 216 of the Radio Unit (RU) 206. In general, the UE operates with no awareness of the SSA and initiates a direct to satellite communication. The communication, between the UE and the satellite on the satellite band, may be detected by the SSA at a neighboring ORAN. Generally, the UE may be attached to the network at the ORAN for communication with a core network of the mobile communications network.

In step 254, the SSA monitors the traffic to assess the quality of the communication signals. Any suitable quality measure such as key performance indicators may be assessed by the SSA. In examples, the RF front end of the ORAN monitors traffic and channel characteristics for the UI and may produce statistics for the channel. The SSA may receive this information or may perform further signal processing to monitor traffic quality between the UE and the satellite.

As the SSA monitors the traffic, at step 256 the SSA determines if the key performance indicators (KPIs) are satisfactory. Examples of useful KPIs include a bit error rate and a number of dropped packets or retransmissions. The SSA in general seeks to determine if the quality of the communication between the UE and the satellite degrades to the point where the SSA should step in as a repeater.

If KPIs remain satisfactory at step 256, and there is no other reason for the SSA to step into the communication, control proceeds to step 257 and continues. Operation of the method 250 may remain in a loop including step 254, step 265 and step 257 so long as communication between UE and satellite is acceptable.

If the KPIs are not met, the process continues to step 258, where the SSA begins operation as a passive repeater for the UE. This step is related to the communication paths illustrated in FIG. 2B, where the UE 212 communicates with both the satellite 128 and a RAN site of the ORAN 202a via signal paths on link 240, link 241, and link 243.

In step 260, the SSA establishes a data communication tunnel with the satellite. Any suitable tunnel may be used such as a GPRS tunnelling protocol (GTP) tunnel, or any other type of data tunnel specified by, for example, the 5G or 6G standard for such communication. Further, the SSA may advise the satellite on beamforming information, such as an angle for pointing a beam toward the UE or a ground station of the ORAN.

Step 262 involves receiving the signal at the SSA from the UE and calculating any delay relative to the repeater signal. This aspect ensures coherent signal reception by the satellite as supported by the MIMO technology. For example, in the context of FIG. 2B, the signal received on the direct link 243 from the UE will arrive at the satellite 128 before the repeater signal from the SSA 242a on the repeater link 240. The time delay information may be communicated from the SSA to the satellite. For example, the SSA may control the RF front end of the ORAN to communicate information with the satellite.

At step 266, the SSA operates to amplify the signal transmitted by the UE on the direct link 234 to the satellite and received by the SSA on the link 241. The satellite does not examine the content of the signal or modify the signal other than providing amplification. For RF transmission, the SSA in combination with the RF front end of the ORAN may filter or shape the signal for reception by the satellite 128, but the repeater signal from the SSA and ORAN is essentially the same as the direct signal from the UE. Step 268 continues the operation of the SSA and ORAN as a passive repeater. This amplification process is central to the passive mode operation of the SSA, where the device enhances satellite communication by selectively amplifying and directing signals based on real-time conditions. Thus, FIG. 2C provides a detailed flow of operations for the SSA in passive mode.

FIG. 2D depicts an illustrative embodiment of a method 270 in accordance with various aspects described herein. The method 270 illustrates one embodiment of operation of an SSA at a RAN site operating in an active mode of operation. Similar to the passive mode, in the active mode of operation, the UE is not aware that the SSA is operating as a repeater. The UE only has information that it is communicating on the satellite frequency, directly with the satellite. The operation of the SSA as a repeater is invisible to the UE. In the active mode, the SSA can have access to the signal content, by virtue of being inline in the communications link between the UE and the satellite. The ORAN may use the signal content including information obtained from the UE and Satellite to perform signal processing on the signal received from the UE and intended for reception by the satellite. Upon processing the signal, the ORAN can intelligently reconstruct the signal, not merely amplifying the signal as in the passive mode of operation. The signal may be reconstructed based on the error detection bits and other integrity mechanisms that may be embedded in the signal.

In the active mode scenario, the communicating satellite and the UE broadcast negotiation packets to look for active amplification stations in the vicinity of the UE. Once an SSA responds to receipt of a negotiation packet, the satellite and the UE ensure that the SSA has the credentials to process the signal and parse the content of the packets to help the SSA amplify the reconstruct the signal if the direct communications between the UE and satellite is sub-optimal. Sub-optimal communication may be determined in any suitable manner such as based on one or more key performance indicators (KPIs) for the communication link between the UE and the satellite. Such KPIs may include a bit error rate, for example, or a number of failed transmissions exceeding predetermined thresholds.

In embodiments, the SSA at an ORAN location performs signal processing to map out the immediate area around the ORAN location. This may be done to correlate the relationship between the UE micro-location and the satellite location. This may be further done to determine the best beam angle direction for use on an uplink from the UE to the satellite and on a downlink from the satellite to the UE. The SSA, based on the signal quality information, may recommend a shooting angle to the UE and Satellite for use on both the uplink and the downlink.

In an example, the SSA serves a coverage area with limited coverage for UEs, such as at the edge of a nature area with heavy tree cover. Users with UEs park their vehicles and head off into the nature area. Based on learned experience, the SSA knows that such users will eventually move into the area with limited coverage where direct to satellite connection will be required but the poor coverage available will limit the reliability of the link between the UE and the satellite. The SSA can thus begin preparations to begin serving as a repeater for the connection, including determining best beamforming information for the UE and for the satellite. The presence of the UE in an area with a difficult radio environment is thus detected and automatically accommodated by the SSA serving as a repeater and actively managing the links between the UE and the satellite.

Because of interference, only a portion of the uplink signal on the direct link to the satellite from the UE may be reliably received by the satellite. All or a portion of the uplink signal may be received by the SSA. The SSA performs error correction and other signal processing to improve the signal, then acting as a repeater, passes the corrected uplink signal to the satellite on a repeater link between the ORAN and the satellite. The SSA may determine a time delay and provide time delay information to the satellite. Using the signal received on the direct link and the signal received on the repeater link, as well as the time delay information, the satellite can reliably reconstruct the signal as transmitted by the UE. Again, this operation by the SSA is wholly transparent to the UE which only has information that it is communicating directly with the satellite.

FIG. 2D illustrates method 270 for operating a Satellite Signal Amplifier (SSA) in an active mode within an Open Radio Access Network (ORAN) system, as depicted in FIGS. 2A and 2B. The method 270 may be performed at any suitable component in a mobile communications network, in particular at the SSA. This method begins with step 272, where the SSA receives user authorization. Such authorization or permission to access user data is obtained for transitioning to active mode. Such authorization allows the SSA to access and process signal content of user.

In step 274, the SSA receives negotiation packets from the User Equipment (UE) 212 and the satellite 128. In the example, the communicating satellite and the UE each broadcast negotiation packets to look for active amplification stations or SSAs in the vicinity of the UE. The SSA may respond by indicating its availability to act as a repeater and otherwise manage the communications between the UE and the satellite. Once an SSA responds, the satellite and the UE ensure that the SSA has the credentials to process the signal and parse the content of the packets to help the SSA improve the signal, amplify, and reconstruct the signal. This step is linked to the communication paths illustrated in FIG. 2B, where the UE communicates with the satellite and the RAN sites of the ORAN 202a and the ORAN 202b via signal paths on link 240, link 241, and link 243. The negotiation packets help establish the SSA's role in the communication link, ensuring it has the necessary credentials to process the signal.

Step 276 involves obtaining credentials, confirming that the SSA is authorized to process the signal content. This step relates to the active mode operation where the SSA accesses signal content for error correction and reconstruction.

In step 278, the SSA detects UE and satellite traffic on the satellite band. This detection is facilitated by the receiver module of the SSA, as shown in FIG. 2A, where the SSA 242 is integrated with the RF front end 216 of the Radio Unit (RU) 206. During the operation of method 270, the UE transmits and receives on a frequency band assigned to satellite communications and generally has no awareness of involvement of the SSA in communicating with the satellite.

Step 280 involves monitoring the traffic to assess the quality of the communication signals. Such monitoring may make use of any quality standard such as key performance indicators compared against one or more predetermined thresholds. The SSA seeks to identify a degradation in communication between the UE and the satellite that falls below a threshold to the point where an intervention by the SSA to serve as a repeater between the UE and the satellite is appropriate.

Step 282 checks if the key performance indicators (KPIs) are satisfactory. If KPIs are satisfied, and if there is no other reason to intervene as a repeater, control returns to step 180 to continue monitoring the UE to satellite traffic. If the KPIs are not met, the process continues to step 286, where the SSA receives the direct signal from the UE. This step is related to the communication paths illustrated in FIG. 2B, where the UE 212 communicates with both the satellite 128 and the RAN sites of the ORAN 202a and of the ORAN 202b. The UE communicates on the assigned satellite band with no awareness that the SSA is receiving signals emitted by the UE.

In step 288, the SSA decodes the received direct signal on the uplink from the UE to the satellite, using the obtained credentials, allowing the SSA to perform error correction in step 290. This step is associated with active mode operation, where the SSA processes the signal using error detection and reconstruction techniques. Any suitable error correction and signal verification technique may be used to improve the accuracy of signals received from the UE at the satellite.

Step 292 involves reconstructing the signal, ensuring that it is optimized for transmission and reception by the satellite. This aspect ensures coherent signal reception by the satellite as described and supported by the MIMO technology.

Finally, step 294 transmits the reconstructed signal on the repeater link to the satellite. Overall, FIG. 2D provides a detailed flow of operations for the SSA in active mode, integrating aspects from FIGS. 2A and 2B, such as the interaction between the UE, satellite, and RAN sites, and the coordination with the SCM for optimal signal processing and transmission.

From the foregoing, it can be seen that aspects of the present disclosure provide an innovative approach to enhancing communication capabilities in areas with limited coverage by integrating dual communication capabilities in mobile devices, thus enabling them to communicate with both satellites and Radio Access Network (RAN) sites. This configuration allows for the amplification of signals to satellites using RAN sites equipped with repeaters, which possess larger earth stations and superior transmission power compared to user equipment such as mobile phones. The technology introduces satellite signal amplifiers (SSA) as part of the Open Radio Access Network (O-RAN) architecture, which can be embedded in various components like the Distributed Unit (DU) or Central Unit (CU). The SSA operates in two modes. In a first passive mode, the system detects and amplifies satellite signals. In a second, active mode, the system accesses signal content for error correction and signal reconstruction. Additionally, the system leverages Multiple Input Multiple Output (MIMO) technology and beamforming to optimize signal reception and transmission, supporting mobility and handovers between satellites and RAN sites. This approach represents a significant advancement over conventional methods by coordinating signals through a massive programmable MIMO system, utilizing satellites and ground antennas for broadband convergence, and addressing challenges such as signal degradation due to environmental factors.

While for purposes of simplicity of explanation, the respective processes are shown and described as a series of blocks in FIG. 2C and FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In view of FIG. 2A, FIG. 2B, FIG. 2C, and FIG. 2D, several alternate embodiments could be considered. One embodiment involves dynamic mode switching, where the Satellite Signal Amplifier (SSA) could be designed to dynamically switch between passive and active modes based on real-time signal conditions and user requirements. This embodiment allows the system to optimize performance and resource utilization by adapting to varying communication environments. Another embodiment involves a decentralized Satellite Core Manager (SCM), where multiple SCMs operate in a distributed manner across different geographical regions, enhancing scalability and reducing latency in coordinating SSAs.

Additionally, the SSA may incorporate advanced signal detection algorithms that utilize machine learning to predict signal degradation and proactively adjust amplification and processing strategies, improving communication reliability. The SSA may also be configured to communicate with multiple satellites simultaneously, allowing for seamless handovers and load balancing between satellites, which would be particularly beneficial in high-traffic or rapidly changing environments.

Localized signal processing may be used another embodiment, where the SSA includes localized processing capabilities to perform initial signal processing and error correction at the RAN site, reducing the load on the central processing system and improving response times.

Energy-efficient operation may be achieved by incorporating energy-efficient components and algorithms that minimize power consumption during low-traffic periods or when operating in passive mode, extending the operational life of the system. A modular design in some embodiments allows the SSA to be designed as a modular system, enabling easy upgrades or replacements of individual components, such as the RF front end or processing units, to adapt to evolving technological standards or specific deployment needs.

Enhanced security features may be included to protect the integrity and confidentiality of the communication signals, particularly when operating in active mode where signal content is accessed and processed. The SSA may also be configured to integrate with other types of networks, such as terrestrial fiber-optic networks or other wireless communication systems, to provide a more comprehensive communication solution. Finally, a user equipment (UE) feedback mechanism may be incorporated, allowing the UE to report its perceived signal quality and other metrics, which the SSA could use to fine-tune its operations. These alternate embodiments aim to enhance the functionality, efficiency, and adaptability of the SSA system, providing robust solutions for satellite communication in various scenarios and environments.

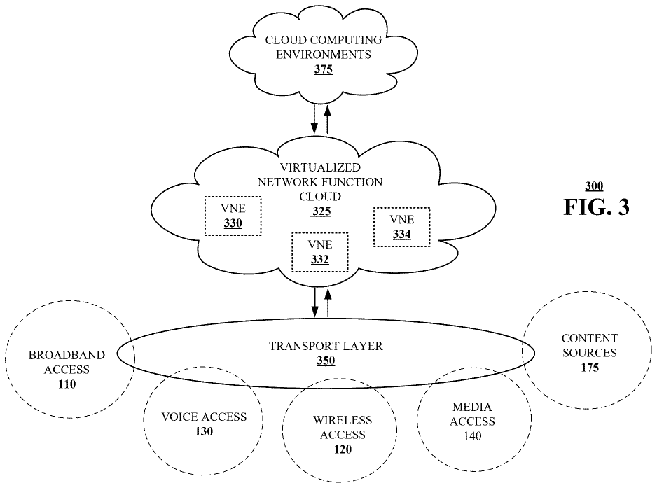

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, method 250 and method 270 presented in FIG. 1, FIG. 2A, FIG. 2B, FIG. 2C, FIG. 2D and FIG. 3. For example, virtualized communication network 300 can facilitate in whole or in part detecting satellite band signals from a user equipment and selectively amplifying the signals in a repeater arrangement to improve reception by a satellite in an environment with limited coverage and substantial interference.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

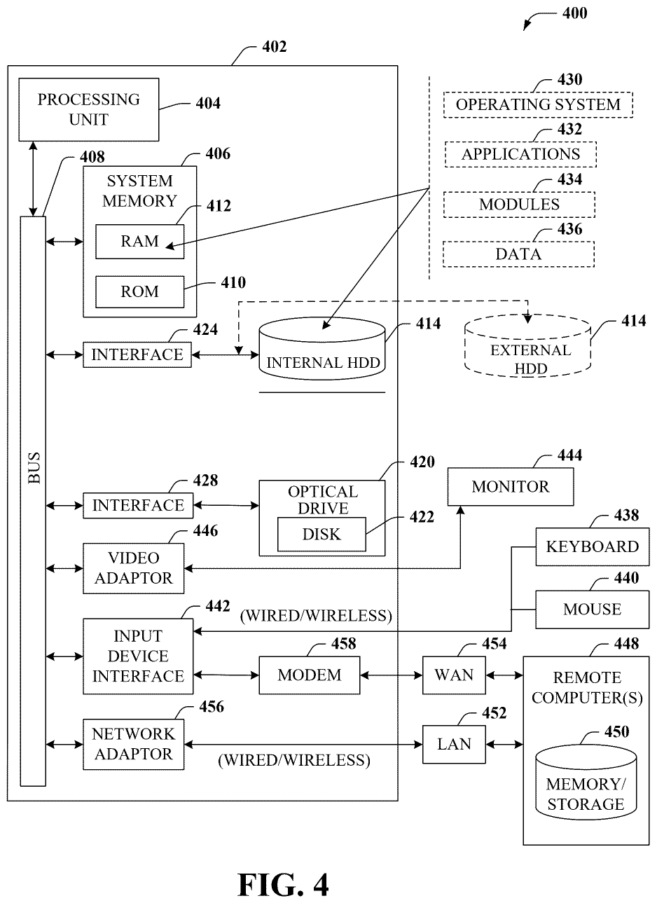

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part detecting satellite band signals from a user equipment and selectively amplifying the signals in a repeater arrangement to improve reception by a satellite in an environment with limited coverage and substantial interference.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are an example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

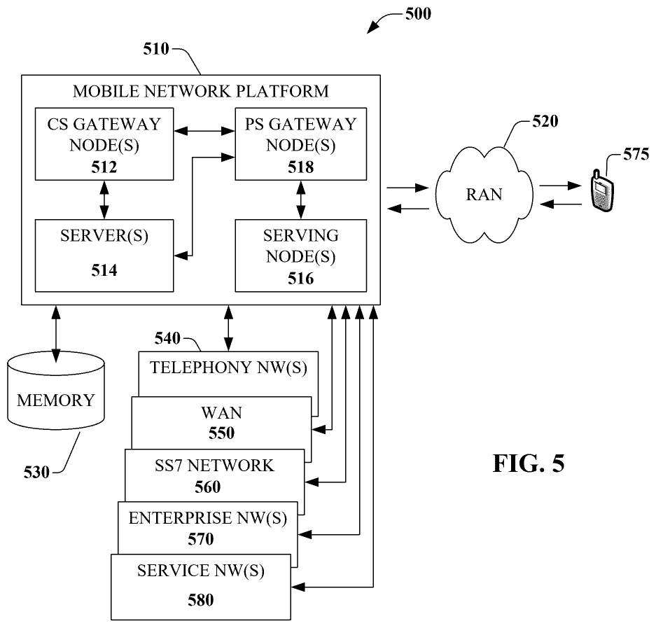

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part detecting satellite band signals from a user equipment and selectively amplifying the signals in a repeater arrangement to improve reception by a satellite in an environment with limited coverage and substantial interference. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated with mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

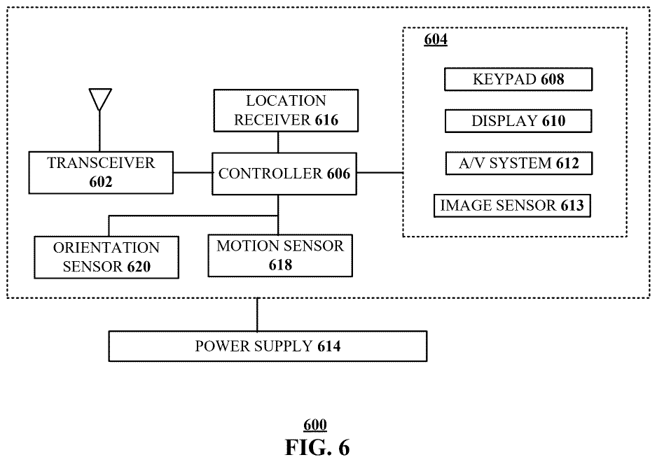

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part detecting satellite band signals from a user equipment and selectively amplifying the signals in a repeater arrangement to improve reception by a satellite in an environment with limited coverage and substantial interference.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, magnetic strips), optical disks (e.g., compact disk (CD), digital versatile disk (DVD)), smart cards, and flash memory devices (e.g., card, stick, key drive). Of course, those skilled in the art will recognize many modifications that can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
detecting satellite band signals from a user equipment (UE), the satellite band signals intended for reception by an earth orbiting satellite;
amplifying the satellite band signals to produce a repeater signal; and
transmitting the repeater signal for reception by the earth orbiting satellite to enhance satellite communication between the UE and the earth orbiting satellite by selectively amplifying and directing communication signals based on real-time signal conditions.

2. The device of claim 1, wherein the device is configured to operate in a passive mode, wherein the device amplifies the satellite band signals, or an active mode, wherein the device processes the satellite band signals using error detection and signal reconstruction.

3. The device of claim 1, wherein the operations further comprise:
analyzing signal characteristics including signal quality, UE location, and satellite location;
determining an optimal transmission beam angle for at least one of the UE and the earth orbiting satellite to enhance the satellite communication between the UE and the earth orbiting satellite; and
communicating information about the optimal transmission beam angle to at least one of the UE and the earth orbiting satellite.

4. The device of claim 1, wherein the operations further comprise:
communicating control and signaling information with a satellite core manager (SCM) for coordinating multiple satellite signal amplifier devices associated with multiple radio access networks of a mobile communications system.

5. The device of claim 4, wherein the communicating the control and signaling information comprises:
communicating handover information between a first device associated with a first radio access network (RAN) of the mobile communication system and a second device associated with a second RAN of the mobile communication system; and
handing over communications with the UE based on the handover information.

6. The device of claim 5, wherein the handing over communications with the UE comprises:
handing over terrestrial communications with the UE from the first RAN to the second RAN of the mobile communications system.

7. The device of claim 5, wherein the handing over communications with the UE comprises:
handing over communications from the earth orbiting satellite to a second satellite of a non-terrestrial communication network.

8. The device of claim 1, wherein the operations further comprise:
obtaining credentials to process the satellite band signals;
parsing content of the satellite band signals, wherein the parsing is responsive to obtaining the credentials;
applying error correction to the satellite band signals;
constructing the repeater signal based on the satellite band signals and the error correction; and
transmitting the repeater signal for reception by the earth orbiting satellite.

9. The device of claim 1, wherein the operations further comprise:
calculating a time delay between the satellite band signals from the UE and the repeater signal; and
communicating information about the time delay to the earth orbiting satellite to facilitate coherent signal reception at the earth orbiting satellite.

10. The device of claim 9, wherein the operations further comprise:
analyzing signal characteristics including signal quality, UE location, and satellite location;
adjusting beamforming parameters for the repeater signal based on the analyzed signal characteristics and the calculated time delay, producing adjusted beamforming parameters; and
transmitting the repeater signal according to the adjusted beamforming parameters.

11. A non-transitory machine-readable medium, comprising executable instructions that, when executed by a processing system including a processor, facilitate performance of operations, the operations comprising:
detecting satellite band signals from a user equipment (UE), the UE attached to a terrestrial communication network, the satellite band signals intended for reception by an earth orbiting satellite of a non-terrestrial communication network;
analyzing a signal quality of the satellite band signals;
selectively amplifying the satellite band signals to produce a repeater signal, wherein the amplifying is based on a comparison between the signal quality of the satellite band signals and a signal quality threshold; and
transmitting the repeater signal for reception by the earth orbiting satellite to enhance satellite communication between the UE and the earth orbiting satellite based on real-time signal conditions.

12. The non-transitory machine-readable medium of claim 11, wherein the operations further comprise:
in an active mode of operation, receiving the satellite band signals from the UE;
applying error correction to the satellite band signals, forming error corrected signals;
constructing the repeater signal based on the error corrected signal; and
amplifying the repeater signal for transmission to the earth orbiting satellite.

13. The non-transitory machine-readable medium of claim 11, wherein the operations further comprise:
determining a best beam angle for the transmitting the satellite band signals; and
communicating information to the UE about the best beam angle.

14. The non-transitory machine-readable medium of claim 13, wherein the operations further comprise:
determining environment characteristics of an environment where the UE is located;
predicting when the comparison between the signal quality of the satellite band signals and the signal quality threshold indicates the satellite band signals should be amplified, based on movement of the UE in the environment where the UE is located; and
initiating the amplifying the satellite band signals to produce the repeater signal in response to the predicting.

15. The non-transitory machine-readable medium of claim 11, wherein the operations further comprise:
calculating a time delay between the satellite band signals from the UE and the repeater signal; and
communicating information about the time delay to the earth orbiting satellite to facilitate coherent signal reception at the earth orbiting satellite.

16. A method, comprising:
detecting, by a processing system including a processor, a transmission of satellite band signals from a user equipment (UE) in a terrestrial communications network, the satellite band signals intended for reception by an earth orbiting satellite of a non-terrestrial communications network;
determining, by the processing system, a signal quality parameter of the satellite band signals;
comparing, by the processing system, the signal quality parameter of the satellite band signals with a signal quality threshold;
selectively causing amplification, by the processing system, of the satellite band signals, forming a repeater signal, wherein the causing amplification is responsive to the comparing of the signal quality parameter of the satellite band signals and the signal quality threshold; and
causing, by the processing system, transmission of the repeater signal for reception by the earth orbiting satellite to enhance satellite communication between the UE and the earth orbiting satellite in response to real time signal degradation of the satellite band signals.

17. The method of claim 16, comprising:
entering, by the processing system, an active mode of operation;
causing, by the processing system, reception of the satellite band signals from the UE, forming received UE signals; and
processing, by the processing system, the received UE signals to improve integrity of the received UE signals in response to real time signal degradation of the satellite band signals, forming the repeater signal.

18. The method of claim 17, wherein the processing the received UE signals comprises:
applying, by the processing system, error correction to the received UE signals to produce the repeater signal.

19. The method of claim 17, comprising:
receiving, by the processing system, negotiation packets from the earth orbiting satellite or the UE or both; and
receiving, by the processing system, signal credentials authorizing the processing of the receive UE signals and parsing content of the received UE signals.

20. The method of claim 16, wherein the determining the signal quality parameter of the satellite band signals comprises:
determining, by the processing system, a key performance indicator (KPI) of the satellite band signals, wherein the KPI is related to reliable signal reception at the earth orbiting satellite of the satellite band signals.
